(19) United States
(12) Patent Application Publication
(10) Pub. No.: US 2004/0193849 A1
(43) Pub. Date: Sep. 30, 2004

(54) Predicated load miss handling

(76) Inventor: James D. Dundas, San Marcos, TX (US)

Correspondence Address: Lester J. Vincent, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/400,015

(22) Filed: Mar. 25, 2003

(51) Int. Cl. G06F 9/44

(52) U.S. Cl. 712/225

(57) ABSTRACT

A technique for predicating a speculative load miss based on a predicate value generated before a branch. More particularly, embodiments of the invention pertain to providing a hint to a processor as to whether a speculative load miss should be serviced, based upon a predicate value.

### FIELD

Embodiments of the invention relate to the field of microprocessor architecture. More particularly, embodiments of the invention relate to predicating load misses in a computer architecture.

### BACKGROUND

Load instruction latency can significantly contribute to microprocessor performance degredation. For example, if load instructions do not retreive intended data in a first level cache, thereby causing a “load cache miss”, the load instruction may be issued to other memory sources in the computer system memory hierarchy having greater access latency than the first level cache. In order to help alleviate the effects of load cache misses, modern compilers typically attempt to schedule load instructions in the program as early as possible.

Techniques, such as inserting loads before a branch instruction within the program can, however, be problematic for some microarchitectures because of possible program faults being generated by the load inserted before the branch. In some microprocessor instruction sets, such as the Intel® IA-64 instruction set, however, it is possible for the compiler to move loads before branches in conjunction with setting special bits, such as a “not a thing” (“NAT”) bit, within various registers of the microarchitecture. Bits, such as NAT bits, may be used by load instructions, such as a speculative load (“Id.s”), to better control program flow in the case of a fault condition caused by performing a load inserted prior to a branch.

In particular, the Intel® 64 bit architecture allows loads to be replaced by Id.s instructions, which can appear before earlier branches in program order. If execution of the Id.s instruction generates a fault, the NAT bit may be set in the load destination register and read to control the flow of program execution.

If, however, control flow of the program does not encounter the original site of the load instruction, then the load instruction may be wasted. Furthermore, if execution of the speculative load generates a cache miss, and therefore the load must be serviced by accessing other memory sources within the computer system memory hierarchy, then the cache line fetched by a load miss operation may eject a useful cache line from the cache, further reducing performance.

Prior art predication techniques have been used to mitigate delay caused by mispredicted branches, and, more particularly, to lessen the performance degredation caused by servicing speculative load misses that are later found not to be useful to the processor.

One prior art predication technique is illustrated in FIG. 1. The predication technique of FIG. 1 has been “if-converted” by replacing “if” statements in the source code with predicated branches. Particularly, the technique illustrated in FIG. 1 moves a speculative load instruction before a branch label in program order. In order to determine whether the speculative load instruction is to be executed, a predicate is associated with the speculative load instruction. If the predicate is equal to a first value, the speculative load is executed, if the predicate is equal to a second value, the speculative load is not executed.

The predicate value can be determined by preempting typical “if” statements in source code or branch operations in machine language with compare operations, which typically require fewer processor cycles than an “if” statement.

Microprocessor architectures, such as those based upon Intel® 64-bit microarchitecture, may take advantage of instruction predication due, at least in part, to the architecture's ability to conditionally execute instructions based upon a predicate value. In predication techniques, branch operations (in machine code) and “if” statements (in source code) are typically replaced by a compare instruction to assign the value of one or more predicates.

The predication technique illustrated in FIG. 1, however, is somewhat restrictive in that the decision of whether to perform a speculative load must be determined before the branch is taken or predicted to be taken. Therefore, in the event that the speculative load is a miss, the processor will continue to service the speculative load by accessing main memory to retreive the data.

In summary, significant delays in microprocessor performance may result from a predicated speculative load miss if subsequent computations within a code thread no longer require the data targeted by the corresponding predicated speculative load. This is due to the fact that a memory controller will typically service the speculative load miss by retrieving the data from another memory source, such as main memory, if the data is not available in cache. Furthermore, if the data is subsequently found not to be necessary (‘useless data’), the delay incurred in retrieving the data is wasted and the retrieved data may in fact result in processor state faults or exceptions.

### BRIEF DESCRIPTION OF THE DRAWINGS

Embodiments and the invention are illustrated by way of example and not limitation in the figures of the accompanying drawings, in which like references indicate similar elements and in which:

FIG. 1 illustrates a prior art technique for predicating speculative load instructions.

FIG. 2 illustrates a technique according to one embodiment of the invention for predicating speculative load misses.

FIG. 3 illustrates a processor architecture according to one embodiment of the invention.

FIG. 4 illustrates a computer system in which one embodiment of the invention may be implemented.

FIG. 5 is a flow diagram illustrating a method for carrying out one embodiment of the invention.

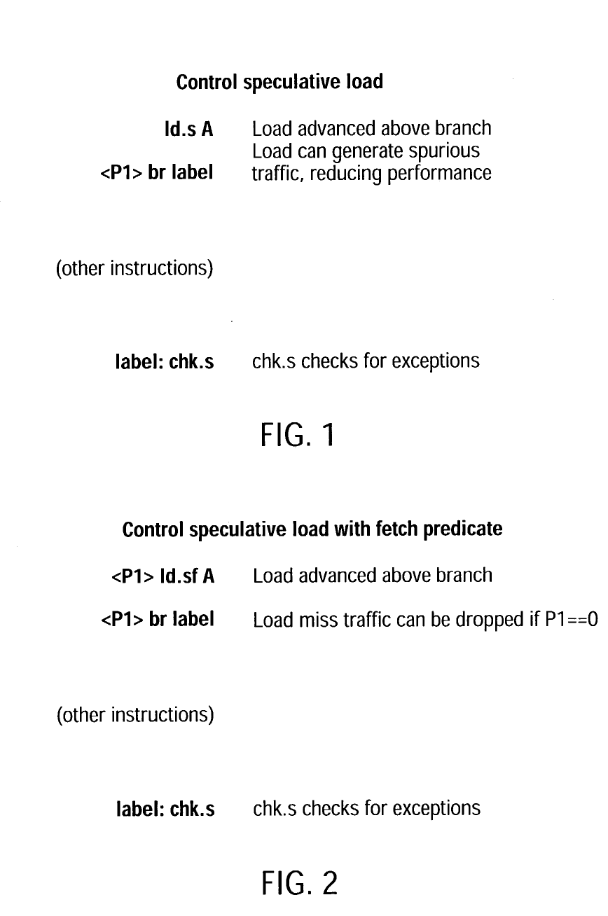

### DETAILED DESCRIPTION

Embodiments of the invention described herein relate to microprocessor architecture, and more specifically, microprocessor instruction predication relating to speculative load miss handling.

One aspect of embodiments of the invention helps reduce loading of useless data resulting from servicing a speculative load miss by using a predicate to provide the processor and instructions executed by the processor a ‘hint’ as to whether it is likely the speculative load miss data will indeed be useful to subsequent instructions in program order.

FIG. 2 illustrates a code segment according to one embodiment of the invention, in which a fetch predicate is used in conjunction with a speculative load placed before a branch label in program order. The speculative load instruction may be an existing speculative load instruction with a fetch predicate included within the instruction or a new instruction, such as Id.sf as illustrated in FIG. 2.

Regardless, the fetch predicate, P1, allows load miss traffic to be disregarded by the processor and subsequent instructions if the predicate value indicates that the speculative load miss data will be useless. Alternatively, the fetch predicate may be a value that indicates to the processor and subsequent instructions that the speculative load miss data will be useful, and the miss may then be serviced by the memory controller to retrieve the load data from memory.

For example, if the predicate evaluates as “false”, the memory system may not service any misses generated by the speculative load instruction containing the fetch predicate, or the memory system may cancel the servicing of the misses after miss servicing has initiated. If, however, the predicate evaluates as “true”, the program has supplied a hint that miss servicing should be allowed for the corresponding speculative load. In either case, the fetch predicate value may be incorrect in some instances, and program correctness, therefore, may not accurately depend upon the fetch predicate. Fetch predicates can evaluate incorrectly, for example, if read out of program order or if they are generated using partial information.

The fetch predicate may be a bit or group of bits encoded into a speculative load instruction, and subsequently decoded by the processor before or while the speculative load instruction is being executed. Advantageously, the fetch predicate may be read at any time after fetching and decoding the speculative load instruction in which it is contained, including after the speculative load instruction has executed. Because the fetch predicate is a hint of whether the speculative load data will be useful, other computations may be performed prior to choosing whether to continue with servicing the speculative load miss or canceling it. The fetch predicate hint, therefore, allows greater flexibility in the implementation of using the fetch predicate by postponing the decision of whether to continue or cancel the speculative load miss handling.

For one embodiment of the invention, the speculative load instruction containing the fetch predicate is itself predicated, whereas in other embodiments it may not be.

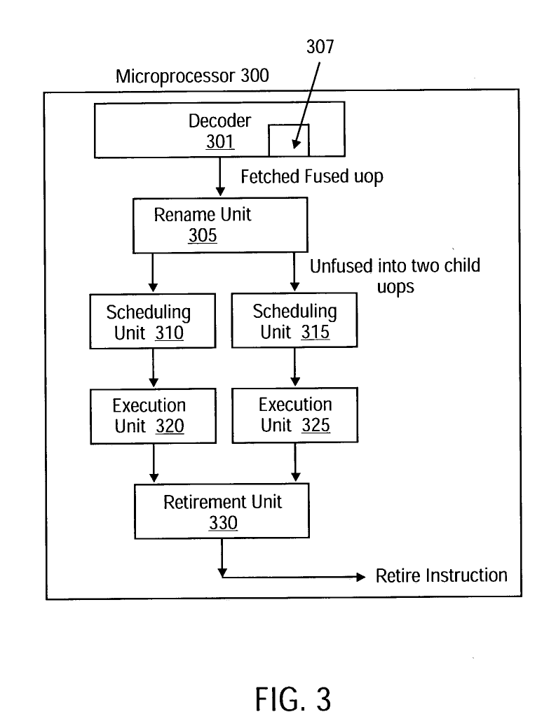

FIG. 3 illustrates a portion of a microprocessor architecture that may be used to perform at least a portion of one embodiment of the invention. Instructions, after being fetched, are decoded by the decoder 301 before they are sent to the rename unit 305. The decoder contains logic 307 to decode a fetch predicate included in the speculative load instruction or other load instruction. In the rename unit, the source and destination registers required by the individual micro-operations (“uops”) of the instructions are assigned. Uops may then be passed to the scheduler 310, 315 where they are scheduled for execution by the execution unit 320, 325. The parallel execution units are used to execute the branches of a pending branch code segment in parallel in order to resolve the correct branch to be taken. This prevents delays in evaluating incorrect branches and also allows predicates to be evaluated properly. After uops are executed they may then be retired by the retirement unit 330.

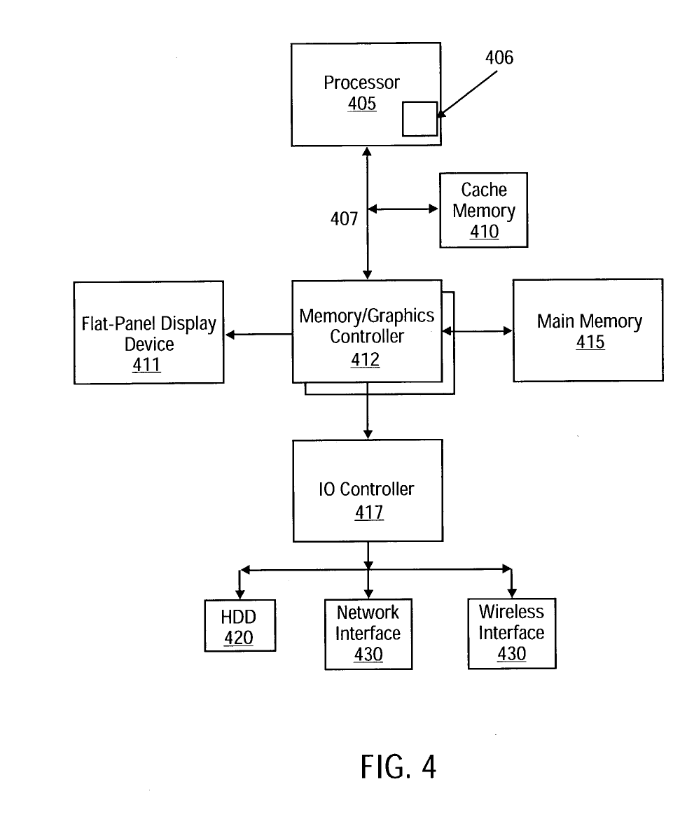

FIG. 4 illustrates a computer system in which at least a portion of one embodiment of the invention may be performed. A processor 405 accesses data from a cache memory 410 and main memory 415, which comprises a memory system. The memory system is used to service speculative load misses depending upon, at least partially, the fetch predicate value.

Illustrated within the processor of FIG. 4 is logic 406 for determining whether to continue with or cancel servicing the speculative load miss, depending, at least in part, upon the hint provided by the fetch predicate included in the speculative load instruction or other load instruction. Some or all of the logic 406, however, may be performed in software, hardware, or a combination of software and hardware.

Furthermore, embodiments of the invention may be implemented within other devices within the system, such as a separate bus agent, or distributed throughout the system in hardware, software, or some combination thereof. The computer system's main memory is interfaced through a memory/graphics controller 412. Furthermore, the main memory may be implemented in various memory sources, such as dynamic random-access memory (“DRAM”). Other memory sources may also be used as the system's main memory and accessed through an input/output controller 417. These memory sources include a hard disk drive (“HDD”) 420, or a memory source 430 located remotely from the computer system containing various storage devices and technologies. The cache memory may be located either within the processor or in close proximity to the processor, such as on the processor's local bus 407. The system may include other peripheral devices, including a display device 411, which may interface to a number of displays, such as flat-panel, television, and cathode-ray tube.

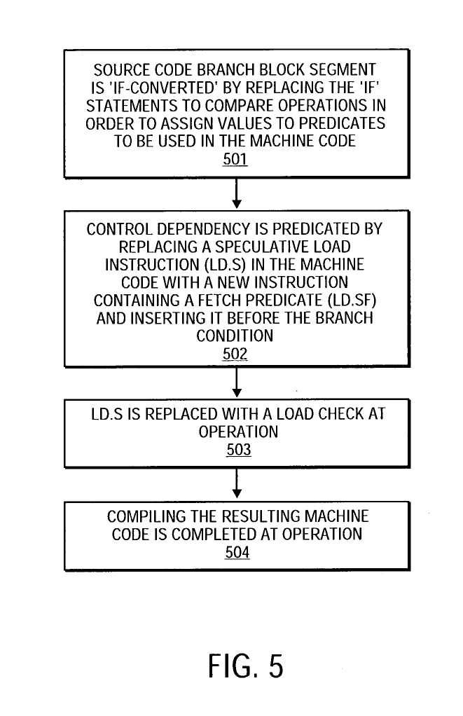

FIG. 5 is a flow diagram illustrating a method for performing one embodiment of the invention. Embodiments of the invention, such as the method illustrated in the flow diagram of FIG. 5, may be implemented by using standard complimentary metal-oxide-semiconductor (“CMOS”) logic (hardware) or a set of instructions (software) stored on a machine-readable medium, which when executed by a machine, such as a processor, cause the machine to perform the method illustrated in FIG. 5. Alternatively, some aspects of the embodiment of the invention may be implemented in hardware and others in software.

Referring to FIG. 5, a source code branch block segment is “if-converted” by replacing the “if” statements to compare operations in order to assign values to predicates to be used in the machine code at operation 501. Control dependency is predicated by replacing a speculative load instruction (“Id.s”) in the machine code with a new instruction containing a fetch predicate (“Id.sf”) and inserting it before the branch condition at operation 502, and Id.s is replaced with a load check at operation at operation 503. Compiling the resulting machine code is completed at operation 504.

Although the invention has been described with reference to illustrative embodiments, this description is not intended to be construed in a limiting sense. Various modifications of the illustrative embodiments, as well as other embodiments, which are apparent to persons skilled in the art to which the invention pertains are deemed to lie within the spirit and scope of the invention.

What is claimed is:

1. A processor comprising:
a decoder unit to decode a load instruction, the load instruction comprising a fetch predicate to indicate whether data loaded as a result of the load instruction being executed is likely to be useful;
an execution unit to execute the load instruction.

2. The processor of claim 1 wherein the load instruction is a speculative load instruction.

3. The processor of claim 1 wherein the fetch predicate is generated by a compare operation.

4. The processor of claim 2 wherein the fetch predicate may be read at any time after the fetch predicate is decoded and before a load miss resulting from executing the speculative load instruction is serviced.

5. The processor of claim 4 further comprising a memory controller to service a speculative load miss resulting from executing the speculative load instruction if the fetch predicate is equal to a first value.

6. The processor of claim 4 further comprising a memory controller to service a speculative load miss resulting from executing the speculative load instruction if the fetch predicate is not equal to a second value.

7. The processor of claim 6 wherein the speculative load instruction is prevented from executing if the fetch predicate is equal to the second value.

8. A machine-readable medium having stored thereon a set of instructions, which when executed by a machine cause the machine to perform a method comprising:
performing a speculative load;
speculatively determine whether load data corresponding to the speculative load is likely to be useful;
servicing a speculative load miss depending, at least in part, upon whether the load data is speculatively determined to be useful.

9. The machine-readable medium of claim 8 wherein the method further comprises preventing a speculative load miss from being serviced if the load data is speculatively determined not to be useful.

10. The machine-readable medium of claim 9 wherein whether the load data is speculatively determined to be useful depends, at least in part, upon a predicate associated with the speculative load.

11. The machine-readable medium of claim 10 wherein the predicate provides a hint as to whether executing the speculative load is likely to result in data being loaded that is not useful to subsequent operations.

12. The machine-readable medium of claim 11 wherein servicing comprises loading the load data from a first memory unit to a second memory unit.

13. The machine-readable medium of claim 12 wherein the speculative load appears in program order before a branch operation upon which the execution of the speculative load depends.

14. The machine-readable medium of claim 13 wherein the predicate is encoded within a speculative load instruction.

15. The machine-readable medium of claim 14 wherein the speculative load instruction is itself predicated.

16. A system comprising:
a processor;
a memory to store a first instruction to predicate a speculative load miss corresponding to a speculative load operation to be executed by the processor.

17. The system of claim 16 wherein the first instruction comprises a predicate bit to indicate whether load data corresponding the speculative load operation is not likely to be used to change a state of the processor.

18. The system of claim 17 further comprising a first cache memory to store the load data to be accessed by the speculative load operation if the predicate bit indicates that the load data is likely to be useful.

19. The system of claim 18 further comprising a memory access unit to service the speculative load miss if the predicate bit indicates that the load data is likely to be useful.

20. The system of claim 19 wherein the predicate bit is to indicate a hint to the memory access unit of whether the load data will not be useful.

21. The system of claim 20 wherein the memory access unit is to prevent completion of servicing the speculative load miss if the load data is not to be useful.

22. The system of claim 21 wherein the memory is dynamic random-access memory.

23. The system of claim 21 wherein the memory is computer system hard disk drive.

24. The system of claim 16 wherein the first instruction is a speculative load instruction comprising a fetch predicate.

25. A method comprising:
if-converting a branch block of code;
predicating control dependency of the branch block of code, the predicating comprising placing a speculative load instruction before a branch condition in program order, the speculative load instruction comprising a fetch predicate to provide a hint as to whether it is likely the speculative load will produce a useful result.

26. The method of claim 25 further comprising compiling the block of code to produce predicated 64-bit computer instructions.

27. The method of claim 26 wherein the speculative load is predicated with the fetch predicate.

28. The method of claim 26 wherein the speculative load is predicated with a different predicate than the fetch predicate.

29. The method of claim 26 wherein the fetch predicate is determined by executing each branch of the branch block of code in parallel to determine which branch will be taken.

30. The method of claim 25 wherein the if-converting comprises replacing ‘if’ statements in the branch block of code with compare operations to produce predicate values.

31. An apparatus comprising:
first means for performing a speculative load;
second means for speculatively determining whether load data corresponding to the speculative load is likely to be useful;
third means for servicing a speculative load miss depending, at least in part, upon whether the load data is speculatively determined to be useful.

32. The apparatus of claim 31 further comprising fourth means for preventing a speculative load miss from being serviced if the load data is speculatively determined not to be useful.

33. The apparatus of claim 32 wherein whether the load data is speculatively determined to be useful depends, at least in part, upon a predicate associated with the speculative load.

34. The apparatus of claim 33 wherein the predicate provides a hint as to whether executing the speculative load is likely to result in data being loaded that is not useful to subsequent operations.

35. The apparatus of claim 34 wherein the third means comprises a fifth means for loading the load data from a first memory unit to a second memory unit.

36. The apparatus of claim 35 wherein the speculative load appears in program order before a branch operation upon which the execution of the speculative load depends.

37. The apparatus of claim 36 wherein the predicate is encoded within a speculative load instruction.

38. The apparatus of claim 37 wherein the speculative load instruction is itself predicated.
